(19) United States
(12) Patent Application Publication
(10) Pub. No.: US 2025/0253591 A1
(43) Pub. Date: Aug. 7, 2025

(54) CONNECTOR SYSTEM AND CONNECTOR

(71) Applicant: I-PEX Inc., Kyoto-shi (JP)

(72) Inventor: Masashi NAKAMURA, Fukuoka (JP)

(21) Appl. No.: 19/188,030

(22) Filed: Apr. 24, 2025

Related U.S. Application Data
(63) Continuation of application No. PCT/JP2023/037226, filed on Oct. 13, 2023.

(30) Foreign Application Priority Data
Oct. 26, 2022 (JP) 2022-171219

(51) Int. Cl. H01R 13/6581

(52) U.S. Cl. CPC H01R 13/6581

(57) ABSTRACT

A connector system comprising a connector and a mate connector. A conductive mate shell of the mate connector is configured so that the mate shell and a conductive shell of the connector form an enclosure that surrounds a conductive contact of the connector and a conductive mate contact of the mate connector around the fitting orientation. The enclosure includes a first portion formed by the shell without overlapping the mate shell, a second portion formed by the mate shell without overlapping the shell, and one or more third portions formed by the shell and the mate shell overlapped with each other. In a circumferential orientation around the fitting orientation, a length of the first portion is longer than a length of each of the one or more third portions, and a length of the second portion is longer than the length of each of the one or more third portions.

### CROSS-REFERENCE TO RELATED APPLICATIONS

This application is a continuation application of PCT Application No. PCT/JP2023/037226, filed on Oct. 13, 2023, which claims the benefit of priority from Japanese Patent Application No. 2022-171219, filed on Oct. 26, 2022. The entire contents of the above listed PCT and priority applications are incorporated herein by reference.

### BACKGROUND

### Field

The present disclosure relates to a connector system and a connector.

### Description of the Related Art

Japanese Unexamined Patent Publication No. 2019-075315 discloses a receptacle connector connected to a plug connector. The plug connector includes a conductive signal contact member that is connected to an internal conductor of a cable, and a conductive shell portion that surrounds the signal contact member. The receptacle connector includes a conductive contact member that is connected to the signal contact member of the plug connector, and a conductive shell portion that surrounds the contact member and is connected to the shell portion of the plug connector.

### SUMMARY

Disclosed herein is a connector system. The connector system may include: a connector including: an insulating housing; a conductive contact held by the insulating housing; and a conductive shell held by the insulating housing so as to be arranged around the contact; and a mate connector including: a mate insulating housing configured to be fitted to the insulating housing along a fitting orientation; a conductive mate contact held by the mate insulating housing, the mate contact being configured to be in contact with the contact in a fitted state where the mate insulating housing is fitted to the insulating housing; and a conductive mate shell held by the mate insulating housing, the mate shell being configured so that the mate shell and the shell form an enclosure that surrounds the contact and the mate contact around the fitting orientation in the fitted state, wherein the enclosure includes a first portion formed by the shell without overlapping the mate shell, a second portion formed by the mate shell without overlapping the shell, and one or more third portions formed by the shell and the mate shell overlapped with each other, and wherein, in a circumferential orientation around the fitting orientation, a length of the first portion is longer than a length of each of the one or more third portions, and a length of the second portion is longer than the length of each of the one or more third portions.

Additionally, a connector configured to be connected to a mate connector is disclosed herein. The mate connector may include: a mate insulating housing; a conductive mate contact held by the mate insulating housing; and a conductive mate shell held by the mate insulating housing so as to be arranged around the mate contact. The connector may include: an insulating housing configured to be fitted to the mate insulating housing along a fitting orientation; a conductive contact held by the insulating housing, the contact being configured to contact the mate contact in a fitted state where the insulating housing is fitted to the mate insulating housing; and a conductive shell held by the insulating housing, the shell being configured so that the shell and the mate shell form an enclosure configured to surround the contact and the mate contact around the fitting orientation in the fitted, wherein the enclosure includes a first portion formed by the shell without overlapping the mate shell, a second portion formed by the mate shell without overlapping the shell, and one or more third portions formed by the shell and the mate shell overlapped with each other, and wherein, in the circumferential orientation around the fitting orientation, a length of the first portion is longer than a length of each of the one or more third portions, and a length of the second portion is longer than the length of each of the one or more third portions.

### BRIEF DESCRIPTION OF THE DRAWINGS

FIG. 1 is a perspective view illustrating an example connector system.

FIG. 2 is a perspective view of the connector system of FIG. 1 viewed from below.

FIG. 3 is a cross-sectional view taken along line III-III in FIG. 1.

FIG. 4 is a cross-sectional view illustrating a state in which a mate connector in FIG. 3 is fitted into a connector.

FIG. 5 is a perspective view of the connector in FIG. 1 viewed from below.

FIG. 6 is an exploded perspective view of the connector in FIG. 5.

FIG. 7 is a partial enlarged view of FIG. 6.

FIG. 8 is an enlarged view of a shell of the connector viewed from above.

FIG. 9 is an enlarged view of the shell of the connector viewed from below.

FIG. 10 is an exploded perspective view of the mate connector in FIG. 1.

FIG. 11 is a partial enlarged view of FIG. 10.

FIG. 12 is an enlarged view of the mate shell of the mate connector viewed from above.

FIG. 13 is an enlarged view of the mate shell of the mate connector viewed from below.

FIG. 14 is a perspective view illustrating an example combination of the shell and the mate shell.

FIG. 15 is a cross-sectional view illustrating an example enclosure.

FIG. 16 is a perspective view showing a modified example of the shell and the mate shell.

FIG. 17 is a perspective view showing a modified example of the enclosure.

### DETAILED DESCRIPTION

In the following description, with reference to the drawings, the same reference numbers are assigned to the same components or to similar components having the same function, and overlapping description is omitted.

### Connector System

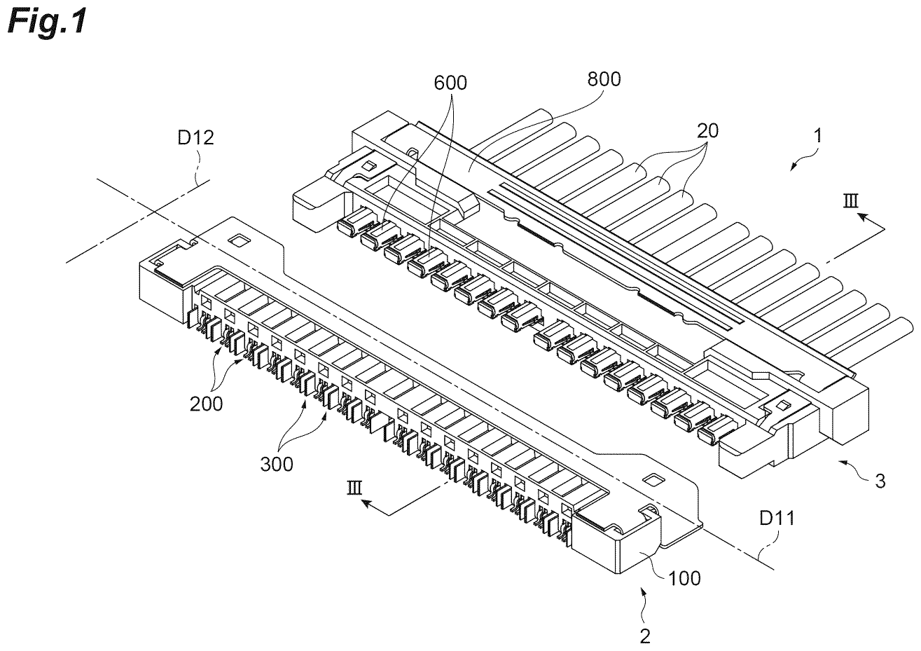

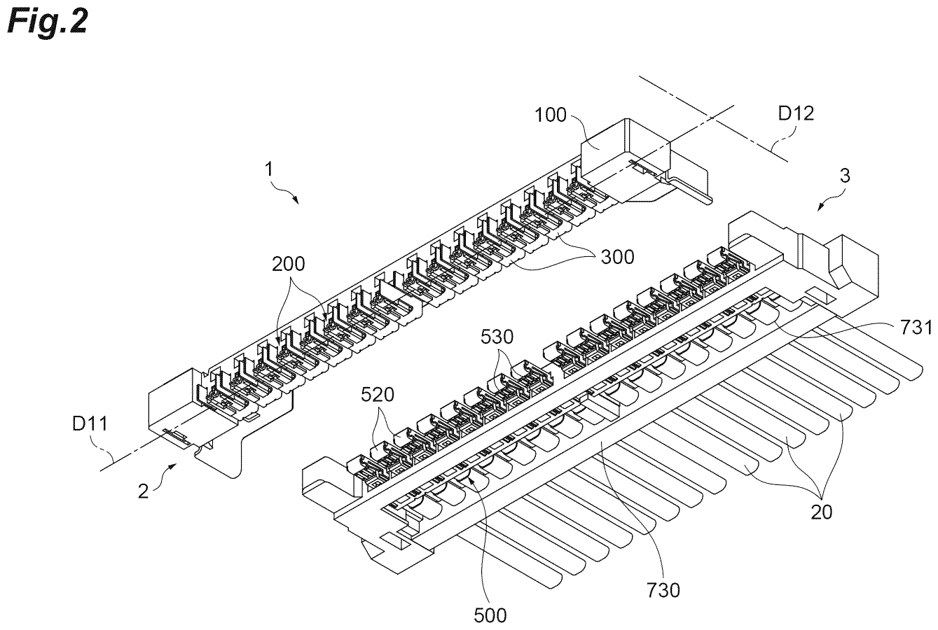

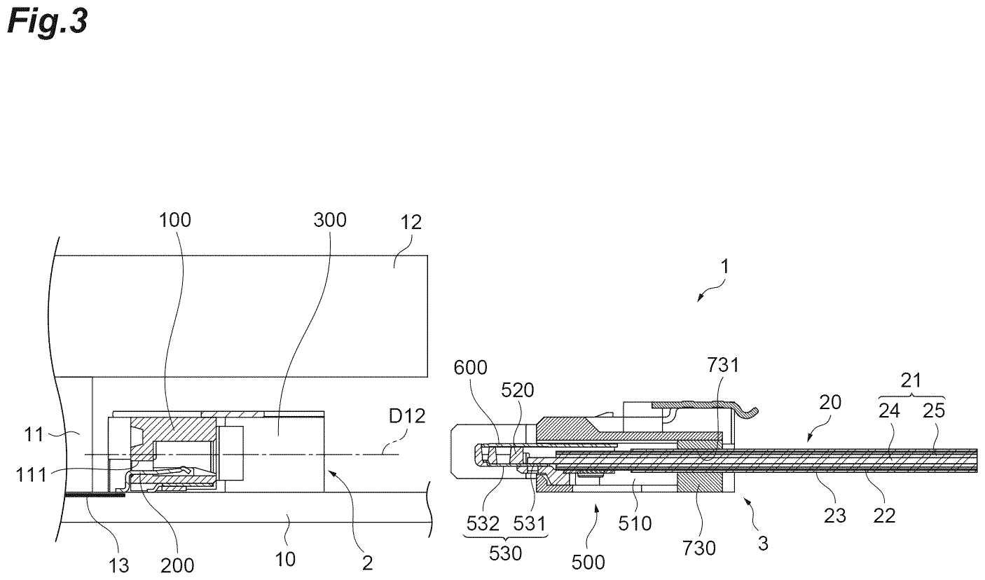

As illustrated in FIGS. 1 and 2, a connector system 1 is used for connecting a circuit board 10 (illustrated in FIG. 3) and a plurality of cables 20 in an application that requires low degradation in transmitting high-frequency signals and low-profile height. One example of such an application is an information processing system in which signals on the circuit board 10 are transmitted by the plurality of cables 20 instead of printed wiring on the circuit board 10. By using a shielded cable or the like for each of the plurality of cables 20, signals can be transmitted with improved signal transmission characteristics compared with those by printed wiring. The signal transmission characteristics refer to how little the signal degradation is in signal transmission, and improved signal transmission characteristics mean that there is little signal degradation in signal transmission. Examples of signal degradation include noise contamination due to crosstalk or the like and signal attenuation.

To further enhance the signal transmission characteristics by the plurality of cables 20, the connection point between the circuit board 10 and the plurality of cables 20 may be closer to a circuit element (for example, a processor) on the circuit board 10. The connection point between the circuit board 10 and the plurality of cables 20 may be provided in the vicinity of the circuit element by making the connector system 1 low-profile to avoid interference with a heat sink or the like provided on the circuit element.

The connector system 1 includes a connector 2 and a connector 3. The connector 2 is, for example, a receptacle connector connected to the circuit board 10. The connector 3 is, for example, a plug connector connected to the plurality of cables 20. The connector 3 is connectable to the connector 2. By connecting the connector 3 to the connector 2, the plurality of cables 20 are electrically connected to the circuit board 10. The connector 2 and the connector 3 are fitted to each other along a fitting orientation D12 parallel to the circuit board 10. Hereinafter, the connector 3 may be referred to as a “mate connector” relative to the connector 2, but this does not mean that only the connector 3 is the “mate connector;” the connector 2 is a “mate connector” relative to the connector 3.

The connector 2 includes a plurality of contacts 200, a plurality of shells 300, and an insulating housing 100. The plurality of contacts 200 are held by the insulating housing 100 so as to be aligned along an arrangement orientation D11 perpendicular to the fitting orientation D12 and parallel to the main surface of the circuit board 10. Each of the plurality of contacts 200 is electrically connected to the circuit board 10 and contacts a signal contact of the mate connector (the connector 3). Each of the plurality of shells 300 is held by the insulating housing 100 so as to be arranged around at least one contact 200. For example, each of the plurality of shells 300 is held by the insulating housing 100 so as to surround at least one contact 200 around an axis along the fitting orientation D12.

The plurality of contacts 200 transmit a plurality of types of signals. The plurality of shells 300 may be provided for the plurality of types of signals respectively. In the region surrounded by each of the plurality of shells 300, one type of signal is transmitted, and other signals are not transmitted. As one example, each of the plurality of contacts 200 may transmit one type of signal based on a ground potential. The plurality of shells 300 are provided for each of the plurality of contacts 200. Each of the plurality of shells 300 surrounds one contact 200 and does not surround another contact 200. The plurality of contacts 200 may include a plurality of pairs of contacts 200 that each transmit a plurality of types of differential signals. The plurality of shells 300 are provided for each of the plurality of pairs of contacts 200. Each of the plurality of shells 300 surrounds one pair of contacts 200 and does not surround another contact 200.

The insulating housing 100 integrally holds the plurality of contacts 200 and the plurality of shells 300. The insulating housing 100 maintains the plurality of contacts 200 in a state of being insulated from each other, maintains the plurality of shells 300 in a state of being insulated from each other, and maintains the plurality of contacts 200 and the plurality of shells 300 in a state of being mutually insulated.

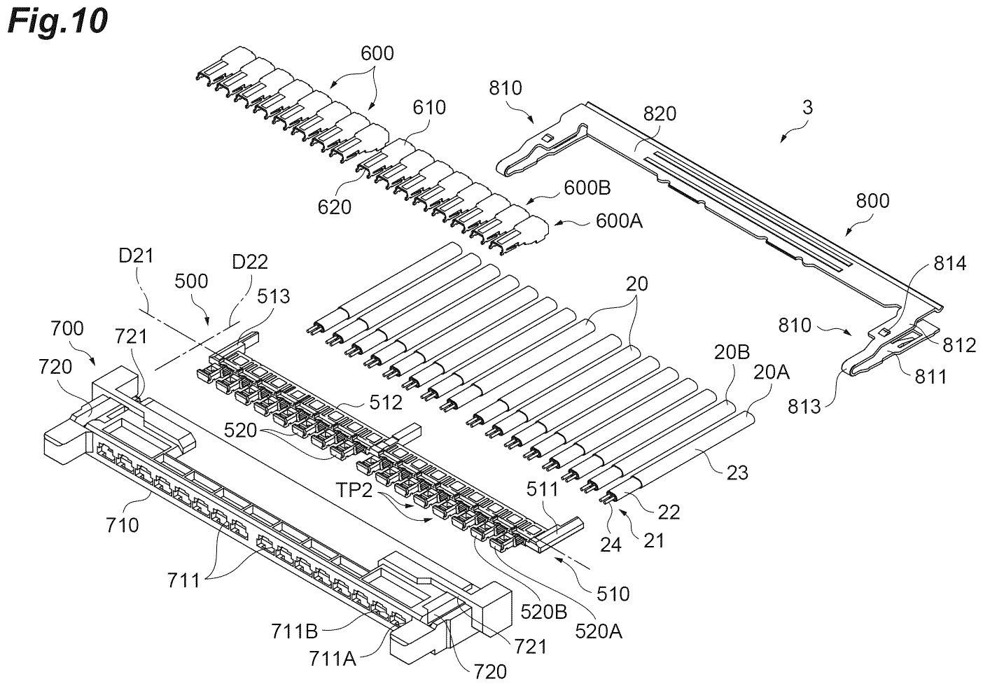

As illustrated in FIGS. 1 and 10, the connector 3 includes a base unit 500 and a plurality of shells 600. The base unit 500 includes a connector base 510, a plurality of insulating housings 520, and a plurality of conductive contacts 530. The connector base 510 extends along the arrangement orientation D11 (D21). The plurality of insulating housings 520 are aligned along the arrangement orientation D11 and each protrude from the connector base 510 in the same orientation along the fitting orientation D12 (D22).

The plurality of contacts 530 are held in the plurality of insulating housings 520 so as to be aligned along the arrangement orientation D11. Each of the plurality of contacts 530 is electrically connected to one of the plurality of cables 20 and comes into contact with the contact 200 of the mate connector (the connector 2). Each of the plurality of insulating housings 520 holds at least one contact 530.

The plurality of contacts 530 transmit the plurality of types of signals described above, and the plurality of insulating housings 520 may be provided for each of the plurality of types of signals. In the plurality of insulating housings 520, one type of signal is transmitted and other signals are not transmitted. For example, each of the plurality of contacts 530 may transmit one type of signal based on the ground potential. The plurality of insulating housings 520 are provided for each of the plurality of contacts 530. Each of the insulating housings 520 holds one contact 530 and does not hold another contact 530. The plurality of contacts 530 may include a plurality of pairs of contacts 530, each pair transmitting one of the plurality of types of differential signals. The plurality of insulating housings 520 are provided for each pair of the contacts 530. Each of the insulating housings 520 holds one pair of contacts 530 and does not hold any other contacts 530.

The plurality of shells 600 respectively correspond to the plurality of insulating housings 520. Each of the plurality of shells 600 surrounds a corresponding insulating housing 520 around an axis along the fitting orientation D12 (D22).

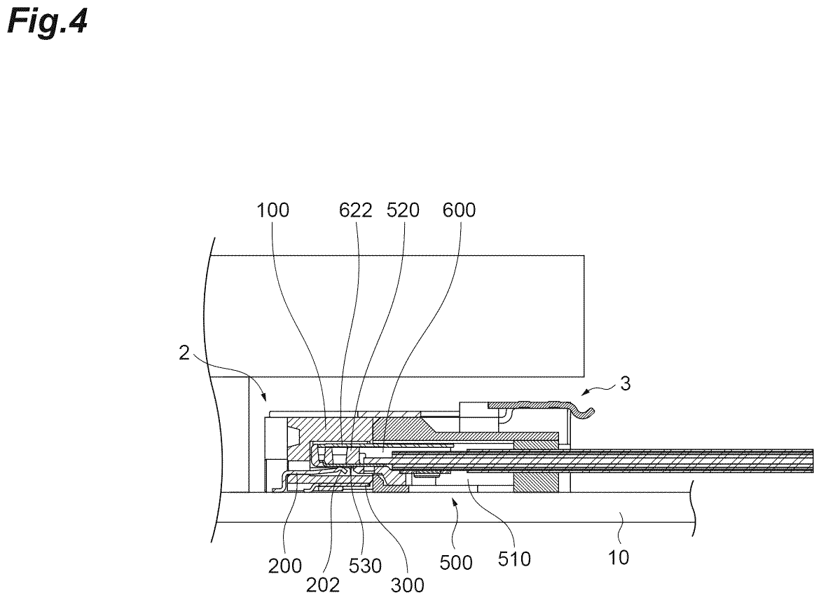

The plurality of insulating housings 520 correspond to the plurality of shells 300, respectively. As illustrated in FIGS. 3 and 4, each of the plurality of insulating housings 520 is inserted into the corresponding shell 300 along the fitting orientation D12. Each of the plurality of shells 600 is fitted into the corresponding shell 300 along the fitting orientation D12. Each of the plurality of contacts 530 contacts the corresponding contact 200 in the corresponding shell 300. Thus, the plurality of cables 20 are electrically connected to the circuit board 10.

In the connector system 1, the relationship between the contact 200 and the shell 300 can be individually optimized by providing an individual shell 300 for each of the plurality of contacts 200. In addition, each shell 300 surrounds the contact 200 around an axis along the fitting orientation D12 parallel to the circuit board 10. Accordingly, the fitting orientation of the connector 3 with respect to the connector 2 is restricted to an orientation parallel to the circuit board 10. Therefore, the height of the connecting portion constituted by the connector 2 and the connector 3 (that is, lower the height with respect to the surface of the circuit board 10) can be lowered. Thus, it is beneficial in achieving both improvement in signal transmission characteristics and reduction in height.

By lowering the height, for example, as illustrated in FIGS. 3 and 4, interference with a heat sink 12 or the like can be avoided and the connector 2 can be disposed in the vicinity of a circuit element 11. Accordingly, further improvement in signal transmission characteristics can be attained.

Each of the plurality of shells 300 may complement surrounding of the insulating housing 520 by the corresponding shell 600. For example, the shell 300 may surround the part of the periphery of the insulating housing 520 that is not surrounded by the shell 600. By thus reducing duplication between the shell 600 and the shell 300, further reduction in height can be achieved.

Hereinafter, more detailed example configurations of the connector 2 and the connector 3 will be described.

### First Connector

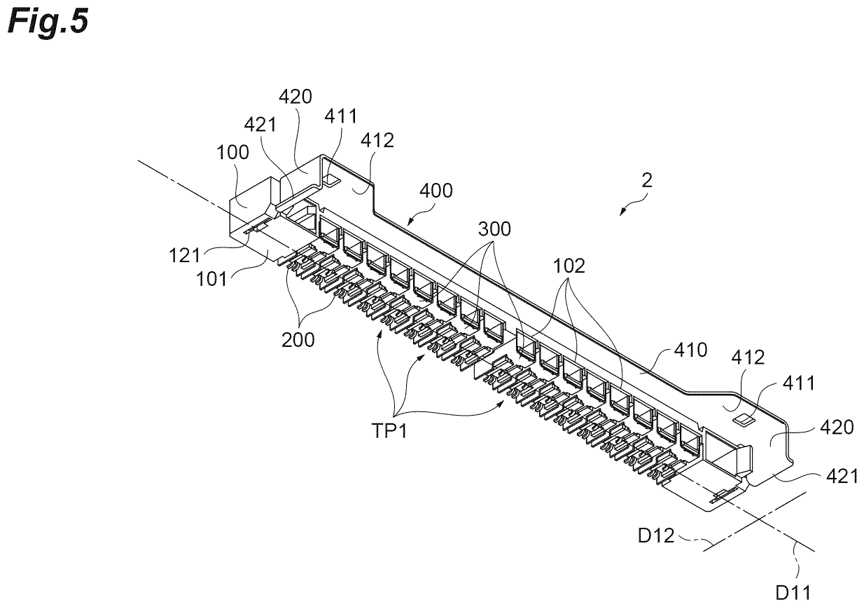

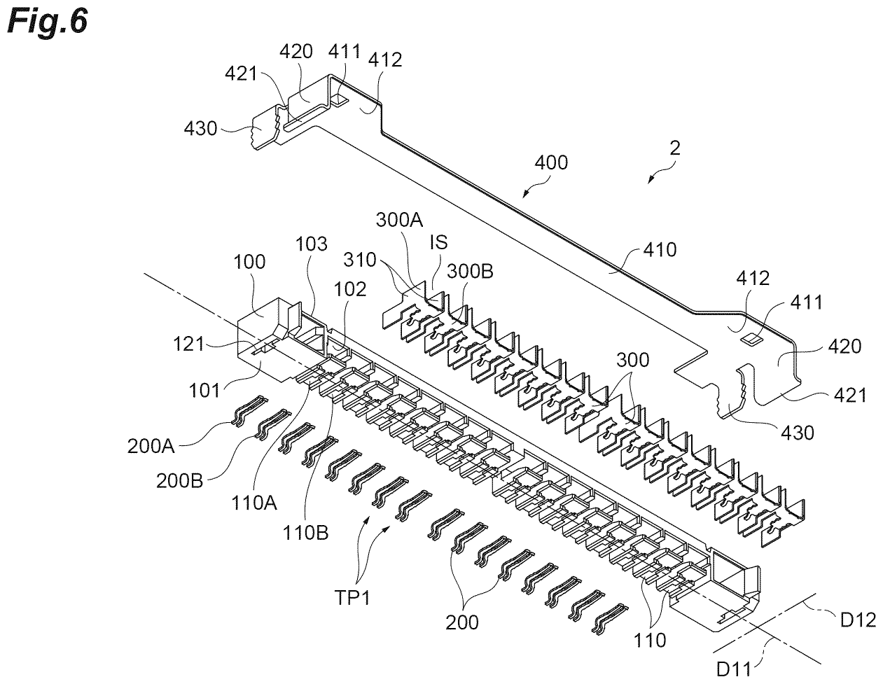

In describing the connector 2, for convenience, a direction toward the surface of the circuit board is referred to as “downward” and a direction away from the surface of the circuit board is referred to as “upward.” FIG. 5 is a perspective view of the connector 2 as viewed from below, and FIG. 6 is an exploded perspective view of the connector 2 in FIG. 5. As illustrated in FIG. 5, the connector 2 includes an insulating housing 100, a plurality of conductive contacts 200, and a plurality of conductive shells 300.

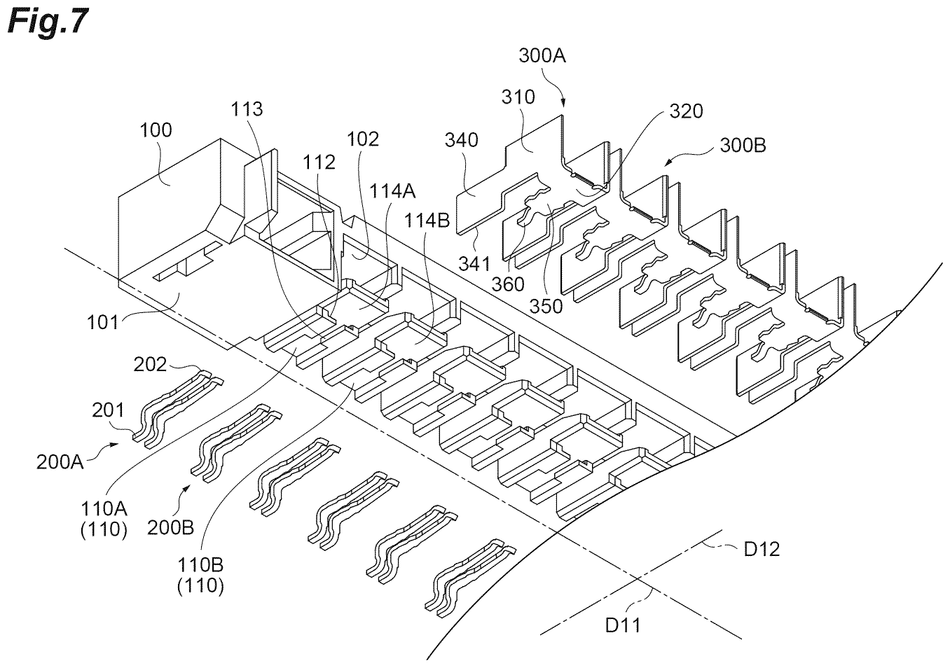

As illustrated in FIGS. 6 and 7, the insulating housing 100 includes a facing surface 101, a recessed surface 102, and a plurality of protrusions 110. The facing surface 101 faces the circuit board 10. The arrangement orientation D11 and the fitting orientation D12 are parallel to the facing surface 101. In a state in which the facing surface 101 faces the circuit board 10, the recessed surface 102 faces the circuit board 10 at a location away from the circuit board 10. The plurality of protrusions 110 are aligned along the arrangement orientation D11 parallel to the facing surface 101 and respectively protrude from the recessed surface 102.

The plurality of protrusions 110 respectively correspond to the plurality of shells 300. Each of the plurality of shells 300 is held by a corresponding protrusion 110. In addition, at least one contact 200 surrounded by each of the plurality of shells 300 is also held by the protrusion 110. For example, a pair of contacts 200 surrounded by each of the plurality of shells 300 are held by the protrusion 110 so as to be aligned along the arrangement orientation D11. The insulating housing 100 is formed by molding a resin material or the like.

One protrusion 110, the shell 300 corresponding thereto, and a pair of contacts 200 corresponding thereto constitute one set of signal transmission portions TP1. The connector 2 includes a plurality of sets of the signal transmission portions TP1 each corresponding to the plurality of protrusions 110. The plurality of sets of the signal transmission portions TP1 are aligned along the arrangement orientation D11, transmitting the plurality of types of signals described above respectively. Hereinafter, as a representative of the plurality of sets of signal transmission portions TP1, more detailed configurations of two sets of the signal transmission portions TP1 that are first and second from the left side in the drawings will be described.

Although the configurations of the plurality of sets of the signal transmission portions TP1 are the same, for convenience of explanation, the protrusion 110, the contacts 200, and the shell 300 belonging to the first signal transmission portion TP1 from the left side in the drawings are referred to as first protrusion 110A, first contacts 200A, and first shell 300A, and the protrusion 110, the contacts 200, and the shell 300 belonging to the second signal transmission portion TP1 from the left side in the drawings are referred to as second protrusion 110B, second contacts 200B (other contacts), and second shell 300B (another shell), thus distinguishing them from one another.

As illustrated especially in FIG. 7, the first contacts 200A and the second contacts 200B are held in the insulating housing 100 so as to be aligned along the arrangement orientation D11. The first contacts 200A and the second contacts 200B are electrically connected to a pair of signal lines 13 on the circuit board 10. The “pair of signal lines 13” respectively connected to the first contacts 200A and the second contacts 200B transmit different signals from each other. If the first protrusion 110A includes the pair of first contacts 200A and the second protrusion 110B includes the pair of second contacts 200B, for example, the pair of first contacts 200A are held by the first protrusion 110A so as to be aligned along the arrangement orientation D11, and the pair of second contacts 200B are held by the second protrusion 110B so as to be aligned along the arrangement orientation D11. Corresponding to the arrangement of the first protrusion 110A and the second protrusion 110B, the pair of first contacts 200A and the pair of second contacts 200B are also aligned along the arrangement orientation D11.

Each of the pair of first contacts 200A is electrically connected to a pair of signal lines 13 on the circuit board 10 that transmit a first differential signal. Each of the pair of second contacts 200B is electrically connected to a pair of signal lines 13 on the circuit board 10 that transmit a second differential signal, which is different from the first differential signal.

Each of the pair of first contacts 200A has a connecting portion 201 (first connecting portion) and a contact portion 202 (first contact portion). The connecting portion 201 is electrically connected to the circuit board 10. For example, the connecting portion 201 is connected by soldering or the like to a conductive signal terminal formed on the circuit board 10. The contact portion 202 protrudes from the connecting portion 201 along the fitting orientation D12 that is parallel to the facing surface 101 and perpendicular to the arrangement orientation D11 and. Hereinafter, for convenience of explanation, a direction in which the contact portion 202 protrudes from the connecting portion 201 is referred to as “front,” and the opposite direction is referred to as “rear.” The first contact 200A is bent into a crank shape between the connecting portion 201 and the contact portion 202 so that the contact portion 202 is located away from the circuit board 10. The first contact 200A is formed by, for example, punching and bending a thin metal sheet or the like.

Each of the pair of second contacts 200B is configured similarly to the first contact 200A and has a connecting portion 201 (second connecting portion) and a contact portion 202 (second contact portion). The connecting portion 201 of the second contact 200B is connected by soldering or the like to a conductive signal terminal formed on the circuit board 10 separately from the signal terminal to which the connecting portion 201 of the first contact 200A is connected.

The first shell 300A is held by the insulating housing 100 so as to be arranged around the pair of first contacts 200A. For example, the first shell 300A is held by the insulating housing 100 so as to surround the pair of first contacts 200A around an axis along the fitting orientation D12 and is electrically connected to the circuit board 10 in a state in which the facing surface 101 faces the circuit board 10.

In the fitting orientation D12, the first shell 300A may partially surround the pair of first contacts 200A. For example, the first shell 300A may surround at least the contact portions 202 of the pair of first contacts 200A.

Within the first shell 300A, any signals other than the one type of signal transmitted by at least one first contact 200A are not transmitted. The one type of signal is transmitted within the first shell 300A. For example, the first differential signal is transmitted in the first shell 300A, and no other signals are transmitted. The first shell 300A surrounds the pair of first contacts 200A and does not surround other contacts 200.

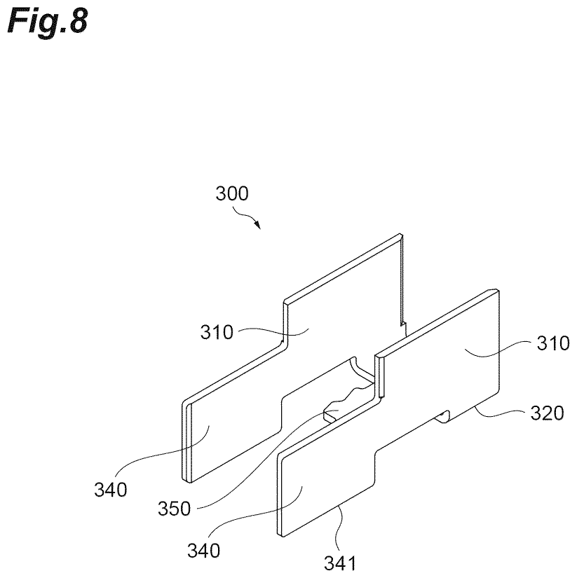

There is no particular limitation on the shape that surrounds the pair of first contacts 200A. The first shell 300A may surround the pair of first contacts 200A in a circular shape, or may surround the pair of first contacts 200A in a polygonal shape. As one example, the first shell 300A may surround the first contact 200A in a rectangular shape. For example, as illustrated in FIG. 8, the first shell 300A may include a pair of side wall portions 310 (first side wall portions) and a base portion 320 (first base portion).

The pair of side wall portions 310 face each other along the arrangement orientation D11. The contact portions 202 of the pair of first contacts 200A are located between the pair of side wall portions 310. The base portion 320 extends parallel to the facing surface 101 and connects the pair of side wall portions 310. In a state where the facing surface 101 faces the circuit board 10, the base portion 320 may be located between the contact portion 202 and the circuit board 10.

As illustrated in FIG. 6, a receiving space IS (first receiving space) is formed between the pair of side wall portions 310. A mate first housing (any one of the plurality of insulating housings 520) of the mate connector (the connector 3) is inserted into the receiving space IS along the fitting orientation D12. A mate shell (shell 600A) of the mate connector is fitted to the first shell 300A, and a mate signal contact (contact 530A) held by the mate first housing comes into contact with the contact portion 202 of the first contact 200A (see FIG. 4). For example, a pair of contacts 530A contact the contact portions 202 of the pair of first contacts 200A, respectively.

As illustrated in FIG. 8, the first shell 300A may further include a pair of projecting portions 340 (first projecting portions), each projecting rearward from the corresponding side wall portion 310. The connecting portions 201 of the pair of first contacts 200A are located between the pair of projecting portions 340.

The first shell 300A may further include a pair of shell connecting portions 341 (first shell connecting portions) respectively formed on the pair of projecting portions 340 so as to be electrically connected to the circuit board 10 in a state where the facing surface 101 faces the circuit board 10. For example, each of the pair of shell connecting portions 341 is formed at a lower edge of the corresponding projecting portion 340 and is connected by soldering or the like to a conductive ground terminal formed on the circuit board 10 separately from the above-described signal terminal. In the circuit board 10, a ground potential is applied to the ground terminal. Hereinafter, the same applies to the ground terminal to which another portion of the shell connecting portion 341 is connected.

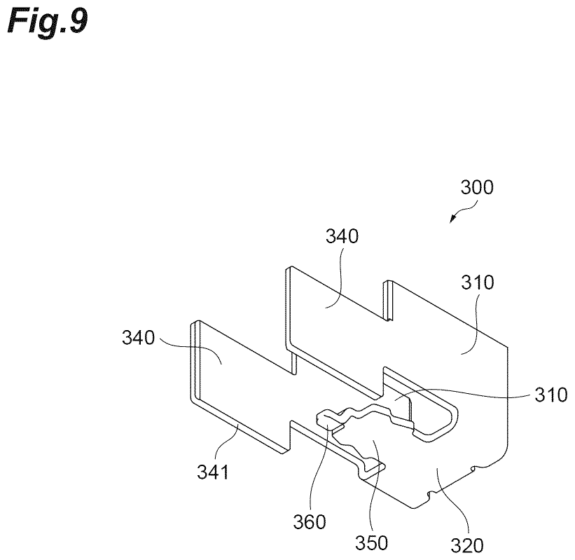

The first shell 300A may further include an anchor portion 350 (first anchor portion) and an intermediate connecting portion 360 (first intermediate connecting portion) (see FIG. 9). The anchor portion 350 projects rearward from the base portion 320 and is held by the first protrusion 110A. The intermediate connecting portion 360 is formed on the base portion 320 so as to be electrically connected to the circuit board 10 in a state where the facing surface 101 faces the circuit board 10. For example, the intermediate connecting portion 360 is formed at a rear end portion of the anchor portion 350 and protrudes from the rear end portion of the anchor portion 350 in a direction away from the recessed surface 102. As one example, the intermediate connecting portion 360 protrudes rearward and downward from the rear end portion of the anchor portion 350 and is connected by soldering or the like to a ground terminal formed on the circuit board 10.

The first shell 300A is formed, for example, by punching and bending a thin metal sheet.

The second shell 300B is held by the insulating housing 100 so as to be arranged around the pair of second contacts 200B. The second shell 300B is held by the insulating housing 100 so as to surround the pair of second contacts 200B around an axis along the fitting orientation D12 and is electrically connected to the circuit board 10 in a state where the facing surface 101 faces the circuit board 10. For example, the second shell 300B may surround at least the contact portions 202 of the pair of second contacts 200B. Within the second shell 300B, no signals other than the one type of signal transmitted by at least one second contact 200B are transmitted. The one type of signal is the signal transmitted within the second shell 300B. For example, the second differential signal is transmitted in the second shell 300B, and no other signals are transmitted. The second shell 300B surrounds the pair of second contacts 200B and does not surround other contacts 200.

The second shell 300B is configured similarly to the first shell 300A and includes a pair of side wall portions 310 (second side wall portions) and a base portion 320 (second base portion). The contact portions 202 of the pair of second contacts 200B are located between the pair of side wall portions 310.

Between the pair of side wall portions 310, a receiving space IS (second receiving space) is formed. A mate second housing (one of the plurality of insulating housings 520) of the mate connector (the connector 3) is inserted into the receiving space IS along the fitting orientation D12. A mate shell (shell 600B) that surrounds the mate second housing is fitted to the second shell 300B, and a mate signal contact (contact 530B) held by the mate second housing comes into contact with the contact portion 202 of the second contact 200B (see FIG. 4). For example, the pair of contacts 530B contact the contact portions 202 of the pair of second contacts 200B, respectively.

Similarly to the first shell 300A, the second shell 300B may further include a pair of projecting portions 340 (second projecting portions) and a pair of shell connecting portions 341. The connecting portions 201 of the pair of second contacts 200B are located between the pair of projecting portions 340. Similarly to the pair of shell connecting portions 341 of the first shell 300A, the pair of shell connecting portions 341 of the second shell 300B are connected by soldering or the like to a ground terminal formed on the circuit board 10.

Similarly to the first shell 300A, the second shell 300B may further include the anchor portion 350 and the intermediate connecting portion 360. The anchor portion 350 projects rearward from the base portion 320 and is held by the second protrusion 110B. The intermediate connecting portion 360 is connected by soldering or the like to a ground terminal formed on the circuit board 10.

As illustrated in FIG. 7, the first protrusion 110A protrudes from the recessed surface 102 and is located between the pair of projecting portions 340 of the first shell 300A, and holds the pair of first contacts 200A and the first shell 300A. For example, the first protrusion 110A has a pair of contact holding holes 111 (located above the first protrusion 110A) and an anchor hole 112. The pair of contact holding holes 111 are aligned along the arrangement orientation D11 and pass through the first protrusion 110A along the fitting orientation D12, respectively. The contact portions 202 of the pair of first contacts 200A are inserted into the pair of contact holding holes 111 from the rear. End portions of the contact portions 202 of the pair of first contacts 200A protrude forward from the first protrusion 110A and are surrounded by the first shell 300A. The anchor hole 112 is located below the pair of contact holding holes 111 and passes through the first protrusion 110A along the fitting orientation D12. The anchor portion 350 of the first shell 300A is inserted into the anchor hole 112 from the front.

A slit 113 (first slit) may be formed in the first protrusion 110A. The slit 113 permits displacement of the intermediate connecting portion 360 along the fitting orientation D12. For example, the slit 113 is formed along the fitting orientation D12 over the entire length of a lower portion of the anchor hole 112, and the intermediate connecting portion 360 is placed in the slit 113. Because the slit 113 extends along the fitting orientation D12, displacement of the intermediate connecting portion 360 along the fitting orientation D12 is permitted.

The insulating housing 100 may further include a first support portion 114A. The first support portion 114A projects forward from the first protrusion 110A and is located between the contact portion 202 and the base portion 320. For example, the first support portion 114A projects forward from the first protrusion 110A between the pair of contact holding holes 111 and the anchor hole 112.

The second protrusion 110B protrudes from the recessed surface 102 and is located between the pair of projecting portions 340 of the second shell 300B, and holds the pair of second contacts 200B and the second shell 300B. For example, similarly to the first protrusion 110A, the second protrusion 110B has a pair of contact holding holes 111 (located above the second protrusion 110B) and an anchor hole 112. The contact portions 202 of the pair of second contacts 200B are inserted into the pair of contact holding holes 111 from the rear. End portions of the contact portions 202 of the pair of second contacts 200B protrude forward from the second protrusion 110B and are surrounded by the second shell 300B. The anchor portion 350 of the second shell 300B is inserted into the anchor hole 112 from the front. Similarly to the first protrusion 110A, the slit 113 (second slit) may be formed in the second protrusion 110B. The intermediate connecting portion 360 of the second shell 300B is placed in the slit 113.

The insulating housing 100 may further include a second support portion 114B similar to the first support portion 114A. The second support portion 114B projects forward from the second protrusion 110B and is located between the contact portion 202 and the base portion 320. For example, the second support portion 114B projects forward from the second protrusion 110B between the pair of contact holding holes 111 and the anchor hole 112.

Referring back to FIGS. 5 and 6, the connector 2 may further include a conductive outer shell 400. The insulating housing 100 has a rear surface 103 of the facing surface 101, and the outer shell 400 covers the rear surface 103.

For example, the outer shell 400 includes a main plate portion 410, a pair of outer side wall portions 420, and a pair of anchor portions 430, and is formed by punching and bending a thin metal sheet material or the like. The main plate portion 410 extends so as to cover at least a portion of the rear surface 103. The pair of outer side wall portions 420 are respectively provided at both end portions of the main plate portion 410 in the arrangement orientation D11. For example, at both end portions of the main plate portion 410, the pair of outer side wall portions 420 bend downward relative to the main plate portion 410 and face each other along the arrangement orientation D11. The pair of anchor portions 430 are also respectively provided at both end portions of the main plate portion 410 in the arrangement orientation D11 and are located rearward of the pair of outer side wall portions 420. For example, at both end portions of the main plate portion 410, the pair of anchor portions 430 bend downward relative to the main plate portion 410 and face each other along the arrangement orientation D11. When viewed from the front, the plurality of shells 300 are located between the pair of outer side wall portions 420 and also located between the pair of anchor portions 430.

The pair of anchor portions 430 are held by the insulating housing 100. For example, the insulating housing 100 may further include a pair of outer holding holes 121 respectively corresponding to the pair of anchor portions 430. Each of the pair of outer holding holes 121 passes vertically through the insulating housing 100. The pair of anchor portions 430 are respectively inserted into the pair of outer holding holes 121 from above.

The pair of outer side wall portions 420 may project forward from the front surface of the insulating housing 100. This allows the connector 3 to be smoothly guided along the fitting orientation D12.

At both end portions of the main plate portion 410, a pair of projecting portions 412 that project forward from the front surface of the insulating housing 100 are respectively formed, and each of the pair of projecting portions 412 is formed with a pair of lock opening 411. When viewed from below, each of the pair of lock openings 411 is located between the plurality of shells 300 and the pair of outer side wall portions 420, respectively. A pair of lock claws 814 of the connector 3, which will be described later, engage with the pair of lock openings 411, respectively.

The outer shell 400 may further include a pair of outer connecting portions 421. The pair of outer connecting portions 421 are respectively formed on the pair of outer side wall portions 420 to be electrically connected to the circuit board 10 in a state where the facing surface 101 faces the circuit board 10. For example, each of the pair of outer connecting portions 421 is formed at the lower edge of the corresponding outer side wall portion 420 and is connected by soldering or the like to a conductive ground terminal formed on the circuit board 10.

### Second Connector

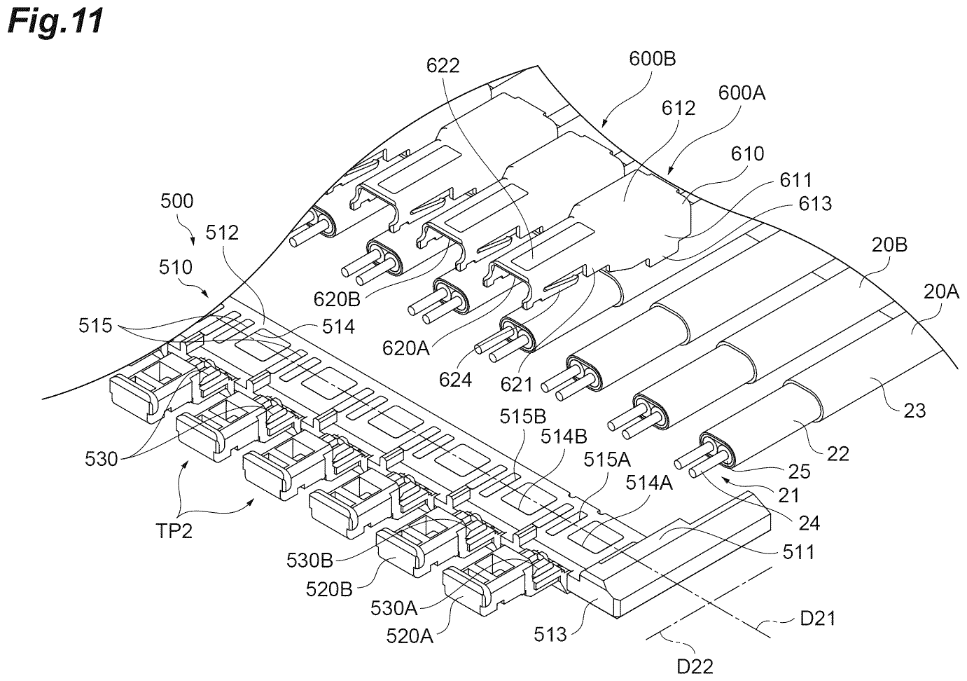

As described above, the connector 3 is connected to the plurality of cables 20. As particularly illustrated in FIG. 11, each of the plurality of cables 20 includes at least one signal conductor 24. One cable 20 transmits one type of signal. For example, the cable 20 transmits one type of differential signal. As one example, one cable 20 includes a pair of wires 21, an outer conductor 22, and an insulating outer sheath 23. Each of the pair of wires 21 includes one signal conductor 24 and an insulating inner sheath 25 that covers the signal conductor 24. Hereinafter, the signal conductors 24 of the pair of wires 21 are referred to as the pair of signal conductors 24. The above differential signal is transmitted by the pair of signal conductors 24. The outer conductor 22 surrounds the pair of wires 21, and the outer sheath 23 covers the outer conductor 22.

FIG. 10 is an exploded perspective view of the connector 3, and FIG. 11 is a partial enlarged view of FIG. 10. As illustrated in FIG. 10, the connector 3 includes the base unit 500 and a plurality of shells 600. As illustrated in FIG. 11, the base unit 500 includes the connector base 510, a plurality of insulating housings 520, and a plurality of conductive contacts 530.

The connector base 510 has a facing surface 511. The facing surface 511 faces an outer periphery of end portions of the plurality of cables 20 aligned along the arrangement orientation D21. The plurality of insulating housings 520 respectively correspond to the plurality of cables 20. The plurality of insulating housings 520 are aligned along the arrangement orientation D21 and each protrude in a direction away from the end portion of the corresponding cable 20 along a fitting orientation D22 parallel to the facing surface 511 and perpendicular to the arrangement orientation D21. In a state where the fitting orientation D12 and the fitting orientation D22 coincide, the plurality of insulating housings 520 are fitted into the insulating housing 100 along the fitting orientations D12, D22. For example, the plurality of insulating housings 520 are respectively fitted into the space between each protrusion 110 and the recessed surface 102.

Hereinafter, for convenience, a direction in which the facing surface 511 faces is referred to as “upward,” and its opposite direction is referred to as “downward.” Furthermore, the direction in which the plurality of insulating housings 520 protrude from the connector base 510 is referred to as “front,” and its opposite direction is referred to as “rear.” According to this definition, the plurality of cables 20 extend rearward from the connector base 510. In a state where the connector 3 is fitted to the connector 2, the upward and downward directions in the description of the connector 2 and the upward and downward directions in the description of the connector 3 coincide. Also, “front” in the description of the connector 3 corresponds to “rear” in the description of the connector 2, and “rear” in the description of the connector 3 corresponds to “front” in the description of the connector 2.

The plurality of contacts 530 include a plurality of pairs of contacts 530 respectively corresponding to the plurality of insulating housings 520. Each of the plurality of pairs of contacts 530 is held by the corresponding insulating housing 520 and contacts the corresponding one of a plurality of pairs of contacts 200 in a state where the insulating housing 520 is fitted to the insulating housing 100. The above-described pair of signal conductors 24 is connected to each of the plurality of pairs of contacts 530.

The plurality of shells 600 respectively correspond to the plurality of insulating housings 520. Each of the plurality of shells 600 is held by the insulating housing 520 and, in a state where the insulating housing 520 is fitted to the insulating housing 100, cooperates with the shell 300 to form an enclosure that surrounds the contacts 200 and the contacts 530 around an axis along the fitting orientations D12, D22. The enclosure will be detailed further below.

The connector 3 includes a plurality of sets of signal transmission portions TP2 corresponding to the plurality of insulating housings 520. The plurality of sets of the signal transmission portions TP2 are aligned along the arrangement orientation D21 and transmit the plurality of types of signals described above, respectively. Hereinafter, as a representative, more detailed configurations of two sets of the signal transmission portions TP2, which are first and second from the right side in the drawings (FIGS. 10 and 11), will be described. The first signal transmission portion TP2 from the right side in the drawings corresponds to the first signal transmission portion TP1 from the left side in FIG. 7. The second signal transmission portion TP2 from the right side in the drawings corresponds to the second signal transmission portion TP1 from the left side in FIG. 7.

Although the plurality of signal transmission portions TP2 have identical configurations, for convenience, the insulating housing 520, the contacts 530, and the shell 600 belonging to the first signal transmission portion TP2 from the right side in FIG. 11 are referenced as a first insulating housing 520A, first contacts 530A, and a first shell 600A, and the insulating housing 520, the contacts 530, and the shell 600 belonging to the second signal transmission portion TP2 from the right side in FIG. 11 are referenced as a second insulating housing 520B, second contacts 530B (other contacts), and a second shell 600B (another shell), respectively. Also, the cable 20 corresponding to the first signal transmission portion TP2 from the right side is referenced as a first cable 20A, and the cable 20 corresponding to the second signal transmission portion TP2 from the right side is referenced as a second cable 20B.

The first insulating housing 520A and the second insulating housing 520B are aligned along the arrangement orientation D21 and protrude forward from the connector base 510 along the fitting orientation D22.

As illustrated in FIG. 11, the first contact 530A and the second contact 530B are electrically connected to the pair of wires 21. For example, the first contact 530A is electrically connected to the signal conductor 24 of the wire 21 of the first cable 20A, and the second contact 530B is electrically connected to the signal conductor 24 of the wire 21 of the second cable 20B. The pair of first contacts 530A are held by the first insulating housing 520A and are respectively connected to the pair of signal conductors 24 of the pair of wires 21 of the first cable 20A. Each of the pair of first contacts 530A has a connecting portion 531 (first connecting portion) and a contact portion 532 (first contact portion) aligned in order toward the front.

The first insulating housing 520A holds the pair of first contacts 530A so that their connecting portions 531 are exposed upward and their contact portions 532 are exposed downward (see FIG. 3). This allows the signal conductor 24 to be connected to the connecting portion 531 from above, and the contact portion 532 can contact the first contact 200A of the mate connector (the connector 2) from above (see FIG. 4).

In the part corresponding to the connecting portion 531 of the leading end portion of the first cable 20A, the outer sheath 23, the outer conductor 22, and the inner sheath 25 are removed, and the exposed pair of signal conductors 24 are respectively connected to the connecting portion 531.

The first contact 530A is formed, for example, by punching and bending a thin sheet of metal or the like.

A pair of second contacts 530B are held in the second insulating housing 520B so as to be aligned with the pair of first contacts 530A along the arrangement orientation D21, and are respectively connected to the pair of signal conductors 24 of the wires 21 of the second cable 20B. Each of the pair of second contacts 530B is configured similarly to the first insulating housing 520A and includes a connecting portion 531 (second connecting portion) and a contact portion 532 (second contact portion).

The second insulating housing 520B holds the pair of second contacts 530B so that the connecting portions 531 are exposed upward and the contact portions 532 are exposed downward (see FIG. 3). This allows the signal conductor 24 to be connected to the connecting portion 531 from above, and the contact portion 532 can contact the second contact 200B of the mate connector (the connector 2) from above (see FIG. 4).

In the leading end portion of the second cable 20B corresponding to the connecting portion 531, the outer sheath 23, the outer conductor 22, and the inner sheath 25 are removed, and the exposed pair of signal conductors 24 are respectively connected to the connecting portion 531.

The first shell 600A is secured to the connector base 510 so as to surround the first insulating housing 520A around an axis along the fitting orientation D22. For example, the first shell 600A includes a cable holding portion 610 (first cable holding portion) and a fitting portion 620 (first fitting portion).

The cable holding portion 610 surrounds the first cable 20A and is secured to the connector base 510. In the part corresponding to the cable holding portion 610 of the leading end portion of the first cable 20A, the outer sheath 23 is removed. The cable holding portion 610 surrounds the outer conductor 22 exposed by removal of the outer sheath 23. There is no particular limitation on the shape that surrounds the outer conductor 22. The cable holding portion 610 may surround the outer conductor 22 in a circular shape, or may surround the outer conductor 22 in a polygonal shape. As an example, the cable holding portion 610 may surround the outer conductor 22 in a rectangular shape. For example, the cable holding portion 610 includes a pair of side wall portions 611 (first base side wall portion) and a base portion 612 (first base portion). The pair of side wall portions 611 face each other along the arrangement orientation D21. The outer conductor 22 of the first cable 20A is located between the pair of side wall portions 611 of the first shell 600A. The base portion 612 extends parallel to the facing surface 511 and connects the pair of side wall portions 611.

The fitting portion 620 extends forward from the cable holding portion 610 along the fitting orientation D22 to surround the first insulating housing 520A. There is no particular limitation on the shape that surrounds the first insulating housing 520A. The fitting portion 620 may surround the first insulating housing 520A in a circular shape, or may surround the first insulating housing 520A in a polygonal shape. As an example, the fitting portion 620 may surround the first insulating housing 520A in a rectangular shape. For example, the fitting portion 620 includes a pair of side wall portions 621 (first side wall portions) and a base portion 622 (first base portion). The pair of side wall portions 621 continue from the pair of side wall portions 611. The base portion 622 continues from the base portion 612 and connects the pair of side wall portions 621.

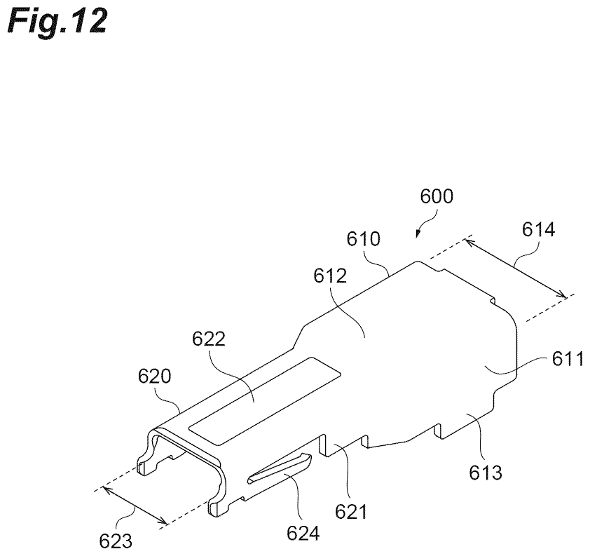

Compared to the gap 614 between the pair of side wall portions 611, the gap 623 between the pair of base portions 622 is smaller (see FIG. 12). While the outer conductor 22 of the first cable 20A is present in the cable holding portion 610, the outer conductor 22 of the first cable 20A is not present in the fitting portion 620. By making the gap 623 at the location where the outer conductor 22 is not present smaller than the gap 614 at the location where the outer conductor 22 is present, the uniformity of the arrangement relationship between the pair of signal conductors 24 and the metal body at ground potential that surrounds the pair of signal conductors 24 can be improved to further enhance signal transmission characteristics.

Returning to FIG. 11, the fitting portion 620A is fitted to an upper portion of the first shell 300A. For example, each of the pair of side wall portions 621 overlaps the inner surface of a corresponding the pair of side wall portions 310 of the first shell 300A. Thus, when the fitting portion 620A is fitted to the first shell 300A, the enclosure of the first insulating housing 520A by the fitting portion 620A is complemented by the first shell 300A. For example, the lower portion of the first insulating housing 520A, which is not surrounded by the fitting portion 620A, is surrounded by the first shell 300A.

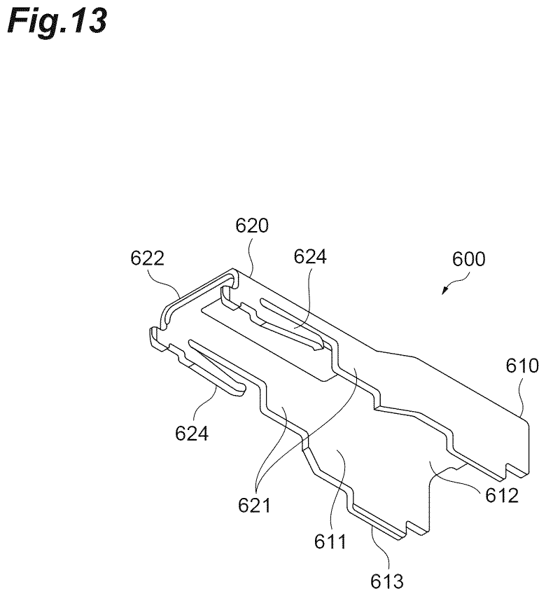

Each of the pair of side wall portions 621 may include an elastic contact portion 624 (first elastic contact portion) (see FIGS. 12 and 13). The elastic contact portion 624 moves closer to the first insulating housing 520A when an external force is applied, and moves away from the first insulating housing 520A when the external force is removed. The elastic contact portions 624 of the pair of side wall portions 621 respectively contact the inner surfaces of the pair of side wall portions 310 of the first shell 300A. In this manner, the enclosure of the first insulating housing 520A by the fitting portion 620A is further firmly complemented by the first shell 300A.

The second shell 600B is secured to the connector base 510 so as to surround the second insulating housing 520B around an axis along the fitting orientation D22. For example, similarly to the first shell 600A, the second shell 600B includes a cable holding portion 610 (second cable holding portion) and a fitting portion 620 (second end portion).

The cable holding portion 610 surrounds the second cable 20B and is secured to the connector base 510. The cable holding portion 610 of the second shell 600B is configured similarly to the cable holding portion 610 of the first shell 600A, and includes a pair of side wall portions 611 (second base side wall portion) and a base portion 612 (second base portion). In the leading end portion of the second cable 20B corresponding to the cable holding portion 610, the outer sheath 23 is removed. The cable holding portion 610 surrounds the outer conductor 22 exposed by removal of the outer sheath 23.

The fitting portion 620 extends forward from the cable holding portion 610 along the fitting orientation D22 to surround the second insulating housing 520B. Similarly to the cable holding portion 610 of the first shell 600A, the fitting portion 620 of the second shell 600B includes a pair of side wall portions 621 (second end side wall portion) and a base portion 622 (second end base portion).

The fitting portion 620B is fitted into an upper portion of the second shell 300B. For example, each of the pair of side wall portions 621 overlaps the inner surface of the pair of side wall portions 310 of the second shell 300B. Thus, when the fitting portion 620B is fitted to the second shell 300B, the enclosure of the second insulating housing 520B by the fitting portion 620B is complemented by the second shell 300B. For example, the lower portion of the second insulating housing 520B, which is not surrounded by the fitting portion 620B, is surrounded by the second shell 300B.

Similarly to each of the pair of side wall portions 621 of the first shell 600A, each of the pair of side wall portions 621 of the second shell 600B may include an elastic contact portion 624 (second elastic contact portion).

The connector base 510 may include a conductive base plate 512 and an insulating base housing 513. The base plate 512 extends along the facing surface 511 and supports the plurality of cables 20 from below. The base housing 513 holds the base plate 512, the first insulating housing 520A, and the second insulating housing 520B. The base unit 500 is formed by molding the base housing 513 and the plurality of insulating housings 520 with a resin material by way of insert-molding in a state where the base plate 512 and the plurality of contacts 530 are placed.

The cable holding portion 610 of the first shell 600A surrounds the outer conductor 22 of the first cable 20A with the pair of side wall portions 611, the base portion 612, and the base plate 512, and is secured to the base plate 512. The cable holding portion 610 of the second shell 600B surrounds the outer conductor 22 of the second cable 20B with the pair of side wall portions 611, the base portion 612, and the base plate 512, and is secured to the base plate 512. The base plate 512 electrically connects the cable holding portion 610 of the first shell 600A and the cable holding portion 610 of the second shell 600B.

In the cable holding portion 610 of the first shell 600A, the outer conductor 22 of the first cable 20A is electrically connected to the base plate 512. For example, the outer conductor 22 is secured to the base plate 512 by soldering or the like. In the cable holding portion 610 of the second shell 600B, the outer conductor 22 of the second cable 20B is electrically connected to the base plate 512. For example, the outer conductor 22 is secured to the base plate 512 by soldering or the like.

The base plate 512 may have a plurality of fixing holes 514 respectively corresponding to the plurality of cables 20. The plurality of fixing holes 514 are aligned along the arrangement orientation D21 and pass through the base plate 512 along a vertical orientation perpendicular to the facing surface 511. Each of the plurality of fixing holes 514 exposes an outer conductor 22 of a corresponding cable 20 downward.

The plurality of fixing holes 514 include a first fixing hole 514A corresponding to the first cable 20A and a second fixing hole 514B corresponding to the second cable 20B. The first fixing hole 514A exposes the outer conductor 22 of the first cable 20A downward, and the second fixing hole 514B exposes the outer conductor 22 of the second cable 20B downward.

As described above concerning the first shell 600A and the second shell 600B, since each of the plurality of shells 600 has the pair of side wall portions 611, the connector 3 has a plurality of pairs of side wall portions 611 aligned along the arrangement orientation D21. On the other hand, the base plate 512 may have a plurality of pairs of shell fixing holes 515 respectively corresponding to the plurality of pairs of side wall portions 611.

The plurality of fixing holes 514 and the plurality of pairs of shell fixing holes 515 are aligned in a row along the arrangement orientation D21. In this arrangement, one fixing hole 514 is located between each of the pairs of shell fixing holes 515. Each of the plurality of pairs of shell fixing holes 515 passes through the base plate 512 along the up-down orientation and exposes the corresponding pair of side wall portions 611 downward. As a result, the plurality of pairs of side wall portions 611 and the outer conductors 22 of the plurality of cables 20 are exposed downward as they are aligned in a row. Thus, the plurality of pairs of side wall portions 611 and the outer conductors 22 of the plurality of cables 20 can be collectively secured to the base plate 512 by soldering or the like from below.

The plurality of pairs of shell fixing holes 515 include a pair of first shell fixing holes 515A respectively corresponding to the pair of side wall portions 611 of the first shell 600A and a pair of second shell fixing holes 515B respectively corresponding to the pair of side wall portions 611 of the second shell 600B. The first fixing hole 514A is located between the pair of first shell fixing holes 515A, and the second fixing hole 514B is located between the pair of second shell fixing holes 515B.

Each of the plurality of pairs of side wall portions 611 may have a fixing piece 613 inserted into the corresponding shell fixing hole 515. For example, each of the pair of side wall portions 611 of the first shell 600A may have a fixing piece 613 (first fixing piece) that is inserted into the corresponding first shell fixing hole 515A. Each of the pair of side wall portions 611 of the second shell 600B may have a fixing piece 613 (second fixing piece) that is inserted into the corresponding second shell fixing hole 515B. Thus, the plurality of shells 600 can be positioned and temporarily fixed with respect to the base plate 512 before being secured by soldering or the like, and workability for fixing the plurality of pairs of side wall portions 611 and the outer conductors 22 of the plurality of cables 20 to the base plate 512 is improved. The fixing piece 613 is secured to the base plate 512 by soldering or the like while being inserted into the corresponding shell fixing hole 515.

Referring back to FIG. 10, the connector 3 may further include an insulating outer housing 700. The outer housing 700 accommodates the connector base 510 with the plurality of shells 600, including the first shell 600A and the second shell 600B, secured thereto. The outer housing 700 may have a front wall portion 710 perpendicular to the fitting orientation D22. The front wall portion 710 may have a plurality of openings 711 respectively corresponding to the plurality of insulating housings 520. Each of the plurality of insulating housings 520 protrudes forward from the outer housing 700 through the corresponding opening 711 while being surrounded by the shell 600.

The plurality of openings 711 include a first opening 711A corresponding to the first insulating housing 520A and a second opening 711B corresponding to the second insulating housing 520B. The first insulating housing 520A protrudes forward from the outer housing 700 through the first opening 711A while being surrounded by the first shell 600A. The second insulating housing 520B protrudes forward from the outer housing 700 through the second opening 711B while being surrounded by the second shell 600B.

The connector 3 may further include an insulating separator 730 that is secured to the outer housing 700 and regulates gaps among the plurality of cables 20, including a gap between the first cable 20A and the second cable 20B. The separator 730 holds the plurality of cables 20 from the outside of the outer sheath 23 behind the connector base 510. The connector base 510 is disposed between the front wall portion 710 and the separator 730. The separator 730 has a plurality of openings 731 respectively corresponding to the plurality of cables 20 (see FIGS. 2 and 3). The plurality of openings 731 are aligned along the arrangement orientation D21. Each of the plurality of openings 731 passes through the separator 730 along the fitting orientation D22. Each of the plurality of cables 20 is retained in the corresponding opening 731. The separator 730 allows suitable distances between the cables 20 to be maintained, thus further improving signal transmission characteristics. The separator 730 can also increase fixing strength of the plurality of cables 20 to the connector 3.

The separator 730 is formed by two-color molding of resin performed in a state where the base unit 500, the plurality of shells 600, and the outer housing 700 are attached to the end portions of the plurality of cables 20. The separator 730 may also be formed by resin sealing with potting. The base unit 500, the plurality of shells 600, and the outer housing 700 may be attached to the end portions of the plurality of cables 20 with the pre-molded separator 730 mounted on the plurality of cables 20. The separator 730 may be shaped by dividing it into an upper member and a lower member around the plurality of openings 731 and the upper and lower members may be shaped so as to sandwich the plurality of cables 20. The separator 730 may be attached to the base unit 500 or may be formed integrally with the base unit 500. Thus, the fixing strength of the plurality of cables 20 to the connector 3 can be further improved.

The connector 3 may further include a lock member 800. The lock member 800 prevents the connector 3 fitted into the connector 2 from coming off. The lock member 800 includes a pair of lock portions 810 and a lock knob 820. The pair of lock portions 810 are held by the outer housing 700 so as to respectively correspond to the plurality of lock openings 411 of the connector 2 (see FIG. 5). At both end portions in the arrangement orientation D21, the outer housing 700 further includes a pair of lock accommodating portions 720 opening upward and rearward, and a pair of hold bars 721 respectively corresponding to the pair of lock accommodating portions 720. Each of the pair of lock portions 810 is housed in the pair of lock accommodating portions 720. Each of the pair of hold bars 721 is located above the rear end of the corresponding lock accommodating portion 720 and holds the lock portion 810 in the lock accommodating portion 720.

Each of the pair of lock portions 810 includes a lock base 811, a lock plate 812, and an elastic connecting portion 813. The lock base 811 extends along the fitting orientation D22 and contacts the bottom surface of the lock accommodating portion 720. The lock plate 812 extends along the fitting orientation D22 at a position away from the bottom surface of the lock accommodating portion 720 and faces the lock base 811 in the vertical orientation. The top surface of the lock plate 812 is formed with a lock claw 814 that engages the lock opening 411 of the connector 2. The elastic connecting portion 813 connects a front end portion of the lock base 811 and a front end portion of the lock plate 812 so as to allow the lock claw 814 to elastically move in the vertical orientation.

The lock portion 810 allows switching between a locked state in which the lock claw 814 engages the lock opening 411 and an unlocked state in which the lock claw 814 does not engage the lock opening 411. For example, when an external force is applied from above the lock plate 812 to move the lock plate 812 closer to the lock base 811, the lock claw 814 is lowered below the main plate portion 410, resulting in the unlocked state. In that state, the connector 3 is fitted to the connector 2, the lock claw 814 is placed below the lock opening 411, and when the external force on the lock plate 812 is removed and the lock plate 812 is elastically returned in a direction away from the lock base 811, the lock claw 814 is positioned in the lock opening 411. Thus, the lock claw 814 engages the inner periphery of the lock opening 411, switching the unlocked state to the locked state. By again applying the external force from above the lock plate 812 to move the lock plate 812 closer to the lock base 811 and thereby lowering the lock claw 814, the locked state is switched to the unlocked state again.

The lock knob 820 is an operation portion configured to simultaneously apply the external force for switching from the locked state to the unlocked state to the lock plates 812 of the pair of lock portions 810. The lock knob 820 extends along the arrangement orientation D21 to connect the lock plates 812 of the pair of lock portions 810 and projects rearward so as to cover above the plurality of cables 20. By pushing the lock knob 820 downward toward the plurality of cables 20, the external force from above is applied simultaneously to the lock plates 812 of the pair of lock portions 810, and the locked state can be switched to the unlocked state. The lock member 800 is formed, for example, by punching and bending a thin metal sheet material or the like.

Because the pair of lock accommodating portions 720 are provided at both ends of the outer housing 700 in the arrangement orientation D21, when viewed from the front, the plurality of insulating housings 520 are arranged between the pair of lock portions 810. By arranging the pair of lock portions 810 at locations that do not overlap the plurality of insulating housings 520, both the reliability of the connector 3 connecting to the connector 2 and the reduction in height of the connector system 1 are achieved.

### Assembly Procedure of the Second Connector

Next, as an example of a connector assembly method, an assembly procedure for the connector 3 will be illustrated. This procedure includes: placing the outer periphery of the first cable 20A so as to face the facing surface 511 and connecting the signal conductor 24 of the first cable 20A to the first contact 530A; placing the outer periphery of the second cable 20B so as to face the facing surface 511 and connecting the signal conductor 24 of the second cable 20B to the second contact 530B; with the signal conductor 24 of the first cable 20A connected to the first contact 530A, placing the first shell 600A so as to surround the first insulating housing 520A around an axis along the fitting orientation D22; fixing the first shell 600A to the connector base 510; with the signal conductor 24 of the second cable 20B connected to the second contact 530B, placing the second shell 600B so as to surround the second insulating housing 520B around an axis along the fitting orientation D22; and fixing the second shell 600B to the connector base 510.

Connecting the signal conductor 24 of the first cable 20A to the first contact 530A and connecting the signal conductor 24 of the second cable 20B to the second contact 530B may be carried out simultaneously. Fixing the first shell 600A to the connector base 510 and fixing the second shell 600B to the connector base 510 may be carried out simultaneously.

The procedure for assembling the connector 3 may further include accommodating the connector base 510, with the first shell 600A and the second shell 600B secured thereto, in the insulating outer housing 700.

Fixing the first shell 600A to the connector base 510 may include soldering the first shell 600A to the base plate 512 via the first shell fixing hole 515A, and soldering the outer conductor 22 of the first cable 20A to the base plate 512 via the first fixing hole 514A. Fixing the second shell 600B to the connector base 510 may include soldering the second shell 600B to the base plate 512 via the second shell fixing hole 515B, and soldering the outer conductor 22 of the second cable 20B to the base plate 512 via the second fixing hole 514B.

Soldering of the first shell 600A to the base plate 512, soldering of the outer conductor 22 of the first cable 20A to the base plate 512, soldering of the second shell 600B to the base plate 512, and soldering of the outer conductor 22 of the second cable 20B to the base plate 512 may be performed all at the same time.

### Enclosure

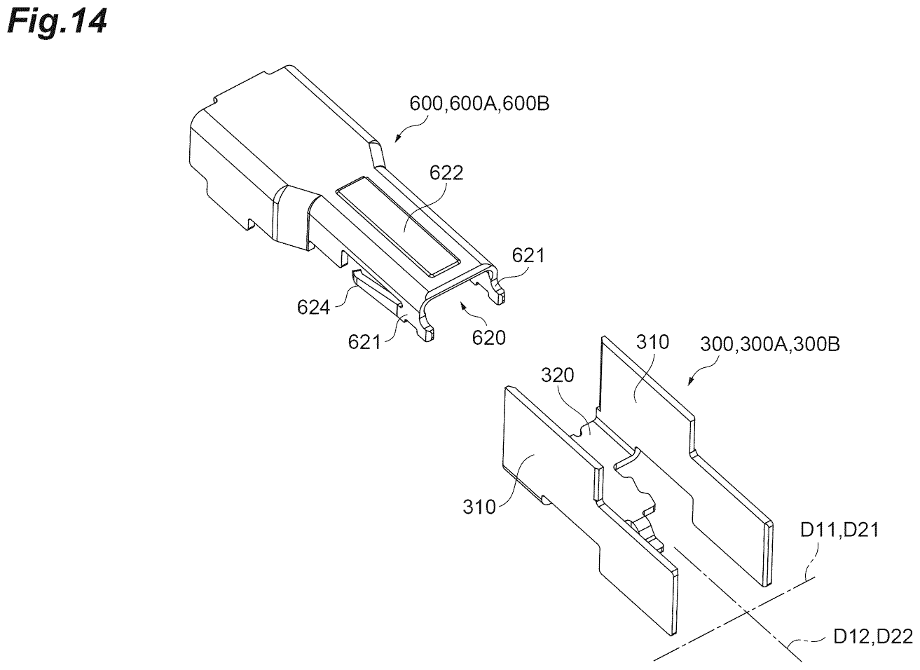

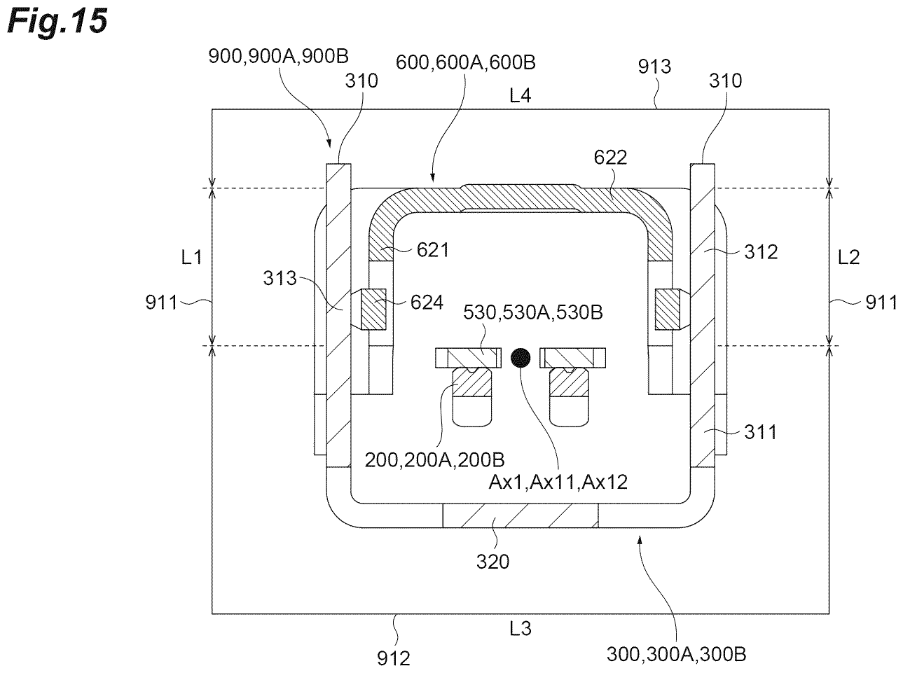

As illustrated in FIGS. 14 and 15, the shell 600 cooperates with the shell 300 to form an enclosure 900 that surrounds the contact 200 and the contact 530 around an axis Ax1 along the fitting orientations D12, D22. For example, the first shell 600A cooperates with the first shell 300A to form a first enclosure 900A, and the second shell 600B cooperates with the second shell 300B to form a second enclosure 900B. The first enclosure 900A surrounds the first contact 200A and the first contact 530A around a first axis Ax11 along the fitting orientations D12, D22. The second enclosure 900B surrounds the second contact 200B and the second contact 530B about a second axis Ax12 along the fitting orientations D12, D22.

In the circumferential orientation around the axis Ax1, the length of a portion where the shell 300 forms the enclosure 900 without overlapping the shell 600 (hereinafter referred to as the “non-overlapping portion 912”), and the length of a portion where the shell 600 forms the enclosure 900 without overlapping the shell 300 (hereinafter referred to as the “non-overlapping portion 913”), are each longer than a total length of one ore more portions where the shell 300 and the shell 600 overlap to form the enclosure 900 (hereinafter referred to as the “one or more overlapping portions 911”). For example, the shell 600 and the shell 300 are not overlap with each other in the non-overlapping portion 912, 913 when viewed from the contact 200 and the contact 530 surrounded by the enclosure 900. If the pair of contacts 200 and the pair of contacts 530 are surrounded by the enclosure 900, the shell 600 and the shell 300 are not over lap with each other in the non-overlapping portion 912, 913 when viewed from at least one of the pair of contacts and at least one of the pair of contacts 530. The shell 600 and the shell 300 are overlap with each other in each of the overlapping portions 911 when viewed from the contact 200 and the contact 530 surrounded by the enclosure 900. If the pair of contacts 200 and the pair of contacts 530 are surrounded by the enclosure 900, the shell 600 and the shell 300 are overlap with each other in each of the overlapping portion 911 when viewed from each of the pair of contacts and each of the pair of contacts 530.

As illustrated in FIG. 15, the non-overlapping portion 912 (a first portion) includes the above-described base portion 320 and part of the pair of side wall portions 310 (a pair of side portions 311). The pair of side portions 311 face each other in a facing orientation (for example, the arrangement orientations D11, D21) perpendicular to the fitting orientations D12, D22. The base portion 320 connects the pair of side portions 311. The non-overlapping portion 913 (a second portion) includes the above-described base portion 622. The base portion 622 faces the base portion 320.

In the one or more overlapping portions 911 (one or more third portions), at two spots aligned along the arrangement orientation D11, parts of the pair of side wall portions 310 (a pair of overlapping portions 312 respectively continuing to the pair of side portions 311) and the pair of side wall portions 621 (a pair of mate overlapping portions) overlap each other. For example, in that facing orientation, the pair of side wall portions 621 face each other and overlap the pair of overlapping portions 312 from inside, maintaining contact with the shell 300. For instance, the pair of side wall portions 621 may remain in contact with the shell 300 by contacting the overlapping portions 312 with an inward elastic displacement of the elastic contact portions 624. This way, at the one or more overlapping portions 911, the shell 300 includes a contact portion 313 (the portion contacting the elastic contact portion 624) configured to contact the shell 600.

The enclosure 900 may continuously surround the contact 200 and the contact 530 without gaps, or may have a gap formed in the enclosure 900 along the circumferential orientation.

At two locations aligned along the arrangement orientation D11, the one or more overlapping portions 911 have lengths L1 and L2 along the circumferential orientation, the non-overlapping portion 912 has a length L3 along the circumferential orientation, and the non-overlapping portion 913 has a length L4 along the circumferential orientation. The length L3 is longer than the sum of the length L1 and the length L2, and the length L4 is longer than the sum of the length L1 and the length L2. As illustrated, each of the length L3 and the length L4 may be at least one-fourth of the entire circumference of the enclosure 900.

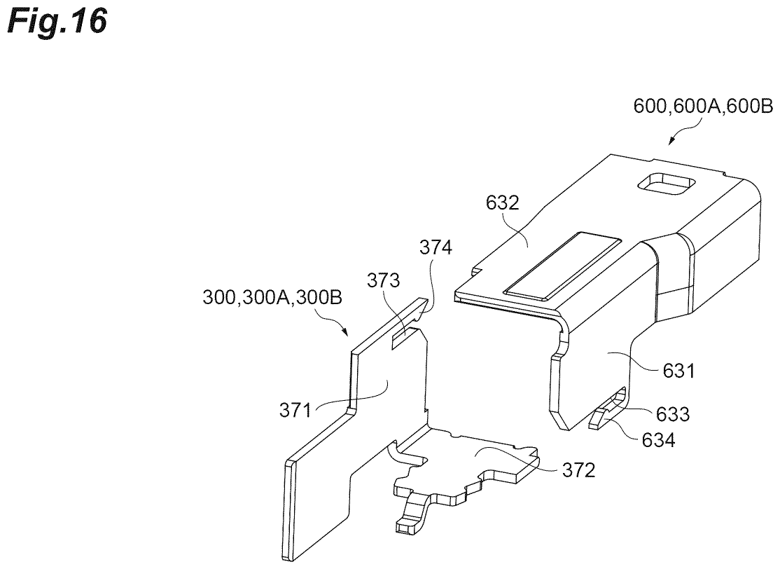

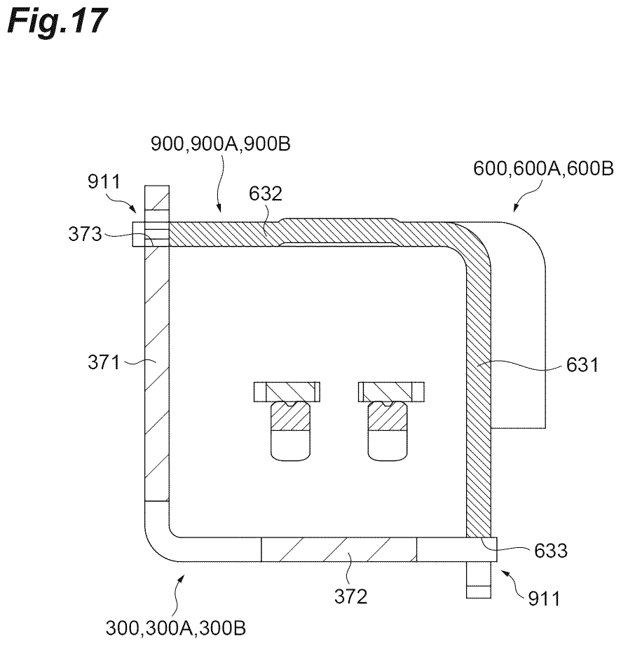

In the above description, a configuration was illustrated in which the shell 300 overlaps with the shell 600 in the arrangement orientations D11, D21 (which intersect, for example, orthogonally) in the circumferential orientation. As illustrated in FIGS. 16 and 17, the shell 300 may be configured to overlap the shell 600 along the circumferential orientation.

In FIGS. 16 and 17, the shell 300 includes a wall portion 371 corresponding to one of the pair of side wall portions 310, and a wall portion 372 corresponding to the base portion 320, and does not have a wall portion facing the wall portion 371. A slit 373 is formed in the wall portion 371 along the arrangement orientation D11. The slit 373 opens toward the shell 600.

The shell 600 includes a wall portion 632 corresponding to the base portion 622 and a wall portion 631 that continues to the wall portion 632 along the circumferential orientation. The wall portion 631 is perpendicular to the wall portion 632. A slit 633 is formed in the wall portion 631 along the arrangement orientation D21. The slit 633 opens toward the shell 300.

The wall portion 632 faces the wall portion 372 and is kept in contact with the shell 300 along the circumferential orientation by fitting into the slit 373 of the wall portion 371. The wall portion 372 is kept in contact with the shell 300 along the circumferential orientation by fitting into the slit 633 of the wall portion 631. At the portion where the wall portion 632 is fitted into the slit 373, and the portion where the wall portion 372 is fitted into the slit 633, the shell 300 overlaps the shell 600 along the circumferential orientation. Because the portion where the shell 300 and the shell 600 overlap along the circumferential orientation forms part of the enclosure 900, both the portion where the wall portion 632 is fitted into the slit 373 and the portion where the wall portion 372 is fitted into the slit 633 correspond to the one or more overlapping portions 911. The length of the one or more overlapping portions 911 in the circumferential orientation is substantially zero.

As illustrated in FIG. 16, a contact protrusion 374 may be formed at an inner edge of the slit 373, protruding inwardly to contact the wall portion 632 (for example, contacting the outer surface of the wall portion 632). Similarly, a contact protrusion 634 may be formed at an inner edge of the slit 633, protruding inwardly to contact the wall portion 372 (the outer surface of the wall portion 372).

The above examples include the following configurations. (1) A connector system 1 comprising: a connector 2 comprising an insulating housing 100; a conductive contact 200 held by the insulating housing 100; and a conductive shell 300 held by the insulating housing 100 so as to be arranged around the contact 200; and a mate connector 3 comprising: a mate insulating housing 520 configured to be fitted to the insulating housing 100 along a fitting orientation D12, a conductive mate contact 530 held by the mate insulating housing 520, the mate contact 530 being configured to contact the contact 200 in a state where the mate insulating housing 520 is fitted to the insulating housing 100; and a conductive mate shell 600 held by the mate insulating housing 520, the mate shell 600 being configured to cooperate with the shell 300 to form an enclosure 900 configured to surround the contact 200 and the mate contact 530 around an axis along the fitting orientation D12 in a state where the mate insulating housing 520 is fitted to the insulating housing 100, wherein, in a circumferential orientation around the axis, a length of a portion where the shell 300 is configured to form the enclosure 900 without overlapping the mate shell 600 and a length of a portion where the mate shell 600 is configured to form the enclosure 900 without overlapping the shell 300 are each longer than a total length of a portion where the shell 300 and the mate shell 600 are configured to overlap to form the enclosure 900.

The enclosure 900 that surrounds the contact 200 and the mate contact 530 can be formed while reducing the portion where the shell 300 and the mate shell 600 overlap. Accordingly, it is beneficial in both reliability of signal transmission and downsizing.

(2) The connector system 1 according to (1), wherein the connector 2 further comprises: a conductive second contact 200B held by the insulating housing 100 so as to be aligned with the contact 200 along an arrangement orientation D11 perpendicular to the fitting orientation D12; and a conductive second shell 300B held by the insulating housing 100 so as to be arranged around the second contact 200B, and wherein the mate connector 3 further comprises: a conductive mate second contact 530B held by the mate insulating housing 520 so as to be aligned with the mate contact 530 along the arrangement orientation D11, the mate second contact 530B being configured to contact the second contact 200B in a state where the mate insulating housing 520 is fitted to the insulating housing 100; and a conductive mate second shell 600B held by the mate insulating housing 520, the mate second shell 600B being configured to cooperate with the second shell 300B to form a second enclosure 900B configured to surround the second contact 200B and the mate second contact 530B around the axis along the fitting orientation D12 in a state where the mate insulating housing 520 is fitted to the insulating housing 100, wherein, in the circumferential orientation around the axis, a length of a portion where the second shell 300B is configured to form the second enclosure 900B without overlapping the mate second shell 600B and a length of a portion where the mate second shell 600B is configured to form the second enclosure 900B without overlapping the second shell 300B are each longer than a total length of a portion where the second shell 300B and the mate second shell 600B are configured to overlap to form the second enclosure 900B. Thus, for the second contact 200B and the mate second contact 530B as well, the second enclosure 900B can be formed while reducing the portion where the second shell 300B and the mate second shell 600B overlap. Therefore, it is further beneficial in achieving both reliability of signal transmission and downsizing.

(3) The connector system 1 according to (2), wherein the contact 200 and the second contact 200B are configured to be electrically connected to a first signal line and a second signal line on the circuit board, and wherein the mate contact 530 and the mate second contact 530B are configured to be electrically connected to a first signal conductor and a second signal conductor of one or more cables. This is beneficial in downsizing the device on which the circuit board is mounted.

(4) The connector system 1 according to (3), wherein the insulating housing 100 comprise a facing surface 101 configured to face the circuit board, and wherein the arrangement orientation D11 and the fitting orientation D12 are parallel to the facing surface 101. This is beneficial in reducing the size of the connector 2 with respect to the circuit board.

(5) The connector system 1 according to any one of (1) to (4), wherein the shell 300 comprises a contact portion 313 configured to contact the mate shell 600 at the portion where the shell 300 and the mate shell 600 are configured to overlap to form the enclosure 900. By contact between the shell 300 and the mate shell 600, the reliability of signal transmission can be further improved.

(6) The connector system 1 according to any one of (1) to (5), wherein the enclosure 900 is configured to continuously enclose the contact 200 and the mate contact 530 without a gap. By contact between the shell 300 and the mate shell 600, the reliability of signal transmission can be further improved.

(7) The connector system 1 according to any one of (1) to (6), wherein each of a length of the portion where the shell 300 is configured to form the enclosure 900 without overlapping the mate shell 600 and a length of the portion where the mate shell 600 is configured to form the enclosure 900 without overlapping the shell 300 accounts for at least one-fourth of the entire circumference of the enclosure 900. This is further beneficial in downsizing.

(8) The connector system 1 according to (7), wherein the portion where the shell 300 is configured to form the enclosure 900 without overlapping the mate shell 600 comprises a pair of side portions 311 facing each other in a facing orientation perpendicular to the fitting orientation D12 and a base portion 320 connecting the pair of side portions 311, and wherein the portion where the mate shell 600 is configured to form the enclosure 900 without overlapping the shell 300 comprises a mate base portion 622 configured to face the base portion 320. This is further beneficial in downsizing.

(9) The connector system 1 according to (8), wherein the shell 300 comprises a pair of overlapping portions 312 respectively continuous with the pair of side portions 311, and wherein the mate shell 600 comprises a pair of mate overlapping portions 621 facing each other in the facing orientation, the mate overlapping portions 621 being configured to respectively overlap from inside the pair of overlapping portions 312 to be kept in contact with the shell 300. This is further beneficial in achieving both reliability of signal transmission and downsizing.

(10) The connector system 1 according to (9), wherein the shell 300 is configured to overlap the mate shell 600 along the circumferential orientation around the axis. This is further beneficial in downsizing. (11) The connector system 1 according to (10), wherein the shell 300 comprises a wall portion 371 formed with a slit 373 along the fitting orientation D12, and wherein the mate shell 600 comprises a mate wall portion 632 intersecting the wall portion 371 and fitting into the slit 373 so as to be kept in contact with the shell 300 along the circumferential orientation. This is further beneficial in achieving both reliability of signal transmission and downsizing.

(12) The connector system 1 according to (11), wherein the mate shell 600 further comprises a mate cross wall portion 631 intersecting the mate wall portion 632, wherein the mate cross wall portion 631 is formed with a mate slit 633 along the fitting orientation D12, and wherein the shell 300 comprises a cross wall portion 372 configured to intersect the mate cross wall portion 631 and be fitted into the mate slit 633 so as to be kept in contact with the mate shell 600 along the circumferential orientation. This is further beneficial in achieving both reliability of signal transmission and downsizing.

(13) A connector 2 configured to be connected to a mate connector 3, the mate connector 3 comprising: a mate insulating housing 520; a conductive mate contact 530 held by the mate insulating housing 520; and a conductive mate shell 600 held by the mate insulating housing 520 so as to be arranged around the mate contact 530, the connector 2 comprising: an insulating housing 100 configured to be fitted to the mate insulating housing 520 along the fitting orientation D12; a conductive contact 200 held by the insulating housing 100, the contact 200 being configured to contact the mate contact 530 in a state where the insulating housing 100 is fitted to the mate insulating housing 520; and a conductive shell 300 held by the insulating housing 100, the shell 300 being configured to cooperate with the mate shell 600 to form an enclosure 900 configured to surround the contact 200 and the mate contact 530 around an axis along the fitting orientation D12 in a state where the insulating housing 100 is fitted to the mate insulating housing 520, wherein, in the circumferential orientation around the axis, a length of a portion where the shell 300 is configured to form the enclosure 900 without overlapping the mate shell 600 and a length of a portion where the mate shell 600 is configured to form the enclosure 900 without overlapping the shell 300 are each longer than a total length of a portion where the shell 300 and the mate shell 600 overlap to form the enclosure 900.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A connector system comprising:
a connector comprising:
an insulating housing;
a conductive contact held by the insulating housing; and
a conductive shell held by the insulating housing so as to be arranged around the contact; and
a mate connector comprising:
a mate insulating housing configured to be fitted to the insulating housing along a fitting orientation;
a conductive mate contact held by the mate insulating housing, the mate contact being configured to be in contact with the contact in a fitted state where the mate insulating housing is fitted to the insulating housing; and
a conductive mate shell held by the mate insulating housing, the mate shell being configured so that the mate shell and the shell form an enclosure that surrounds the contact and the mate contact around the fitting orientation in the fitted state,
wherein the enclosure includes a first portion formed by the shell without overlapping the mate shell, a second portion formed by the mate shell without overlapping the shell, and one or more third portions formed by the shell and the mate shell overlapped with each other, and
wherein, in a circumferential orientation around the fitting orientation, a length of the first portion is longer than a length of each of the one or more third portions, and a length of the second portion is longer than the length of each of the one or more third portions.

2. The connector system according to claim 1,
wherein the length of the first portion is longer than a total length of the one or more third portions.

3. The connector system according to claim 2,
wherein the length of the second portion is longer than a total length of the one or more third portions.

4. The connector system according to claim 1,
wherein the connector further comprises:
another conductive contact held by the insulating housing so as to be aligned with the contact along an arrangement orientation perpendicular to the fitting orientation; and
another conductive shell held by the insulating housing so as to be arranged around the other contact, and
wherein the mate connector further comprises:
another conductive mate contact held by the mate insulating housing so as to be aligned with the mate contact along the arrangement orientation, the other mate contact being configured to be in contact with the other contact in the fitted state; and
another conductive mate shell held by the mate insulating housing, the other mate shell being configured so that the other mate shell and the other shell form another enclosure that surrounds the other contact and the other mate contact around the fitting orientation in the fitted state,
wherein the other enclosure includes another first portion formed by the other shell without overlapping the other mate shell, another second portion formed by the other mate shell without overlapping the other shell, and one or more other third portions formed by the other shell and the other mate shell overlapped with each other, and
wherein, in the circumferential orientation around the fitting orientation, a length of the other first portion is longer than a length of each of the one or more other third portions, and a length of the other second portion is longer than the length of each of the one or more other third portions.

5. The connector system according to claim 4,
wherein the length of the first portion is longer than a total length of the one or more third portions, and
wherein the length of the other first portion is longer than a total length of the one or more other third portions.

6. The connector system according to claim 5,
wherein the length of the second portion is longer than a total length of the one or more third portions, and
wherein the length of the other second portion is longer than a total length of the one or more other third portions.

7. The connector system according to claim 4,
wherein the contact is configured to be electrically connected to a signal line on a circuit board, and the other contact is configured to be electrically connected to another signal line on the circuit board, and
wherein the mate contact is configured to be electrically connected to a signal conductor of one or more cables, and the other mate contact is configured to be electrically connected to another signal conductor of the one or more cables.

8. The connector system according to claim 7,
wherein the insulating housing comprises a facing surface configured to face the circuit board, and
wherein the arrangement orientation and the fitting orientation are parallel to the facing surface.

9. The connector system according to claim 1,
wherein the shell comprises a contact portion configured to contact the mate shell at the one or more third portions.

10. The connector system according to claim 1,
wherein the enclosure is configured to continuously surround the contact and the mate contact without a gap along the circumferential orientation.

11. The connector system according to claim 1,
wherein a length of the first portion is equal to or longer than one-fourth of an entire circumference of the enclosure.

12. The connector system according to claim 11,
wherein a length of the second portion is equal to or longer than one-fourth of an entire circumference of the enclosure.

13. The connector system according to claim 11,
wherein the first portion comprises:
a pair of side portions facing each other in a facing orientation perpendicular to the fitting orientation with the contact in between; and
a base portion connecting the pair of side portions, and
wherein the second portion comprises a mate base portion configured to face the base portion.

14. The connector system according to claim 13,
wherein the shell comprises a pair of overlapping portions respectively continuous with the pair of side portions, and
wherein the mate shell comprises a pair of mate overlapping portions facing each other in the facing orientation with the mate contact in between, the pair of mate overlapping portions being configured to respectively overlap from inside the pair of overlapping portions to be kept in contact with the shell.

15. The connector system according to claim 14,
wherein the shell is configured to overlap the mate shell along the circumferential orientation.

16. The connector system according to claim 15,
wherein the shell comprises a wall portion formed with a slit along the fitting orientation, and
wherein the mate shell comprises a mate wall portion configured to be fitted into the slit to intersect the wall portion in the fitted state so that the mate wall portion is kept in contact with the shell along the circumferential orientation.

17. The connector system according to claim 16,
wherein the mate shell further comprises a mate cross wall portion intersecting the mate wall portion,
wherein the mate cross wall portion is formed with a mate slit along the fitting orientation, and
wherein the shell comprises a cross wall portion configured to be fitted into the mate slit to intersect the mate cross wall portion so that the cross wall portion is kept in contact with the mate shell along the circumferential orientation.

18. A connector configured to be connected to a mate connector, the mate connector comprising:
a mate insulating housing;
a conductive mate contact held by the mate insulating housing; and
a conductive mate shell held by the mate insulating housing so as to be arranged around the mate contact,
the connector comprising:
an insulating housing configured to be fitted to the mate insulating housing along a fitting orientation;
a conductive contact held by the insulating housing, the contact being configured to contact the mate contact in a fitted state where the insulating housing is fitted to the mate insulating housing; and
a conductive shell held by the insulating housing, the shell being configured so that the shell and the mate shell form an enclosure configured to surround the contact and the mate contact around the fitting orientation in the fitted state,
wherein the enclosure includes a first portion formed by the shell without overlapping the mate shell, a second portion formed by the mate shell without overlapping the shell, and one or more third portions formed by the shell and the mate shell overlapped with each other, and
wherein, in a circumferential orientation around the fitting orientation, a length of the first portion is longer than a length of each of the one or more third portions, and a length of the second portion is longer than the length of each of the one or more third portions.

19. The connector according to claim 18,
wherein the length of the first portion is longer than a total length of the one or more third portions.

20. The connector according to claim 19,
wherein the length of the second portion is longer than a total length of the one or more third portions.
